(19) United States
(12) Patent Application Publication
(10) Pub. No.: US 2016/0252622 A1
(43) Pub. Date: Sep. 1, 2016

(54) APPARATUS, SYSTEM AND METHOD OF COMMUNICATING ASSISTED GLOBAL NAVIGATION SATELLITE SYSTEM (A-GNSS) INFORMATION

(71) Applicants: Tirosh Levin, Hadera (IL); Ron Rotstein, Tel Aviv (IL); Chandru Aswani, Karnataka (IN); Gil Zukerman, Hod HaSharon (IL)

(72) Inventors: Tirosh Levin, Hadera (IL); Ron Rotstein, Tel Aviv (IL); Chandru Aswani, Karnataka (IN); Gil Zukerman, Hod HaSharon (IL)

(21) Appl. No.: 14/227,440

(22) Filed: Mar. 27, 2014

(51) Int. Cl. G01S 19/25; H04B 1/3827; H04W 4/02; G01S 19/05; G01S 19/12

(52) U.S. Cl. CPC G01S 19/25; G01S 19/05; G01S 19/12; H04W 4/021; H04B 1/3827; H04W 84/042

(57) ABSTRACT

Some demonstrative embodiments include devices, systems and/or methods of communicating Assisted Global-Navigation-Satellite-System (A-GNSS) information. For example, a portable device may include may include a Global-Navigation-Satellite-System (GNSS) receiver to receive GNSS information from a plurality of satellites; a non-cellular transceiver to receive Assisted-GNSS (A-GNSS) information from a cellular device via a non-cellular network; and a processor to process the GNSS information based on the A-GNSS information.

### TECHNICAL FIELD

Embodiments described herein generally relate to communicating assisted global navigation satellite system (A-GNSS) information.

### BACKGROUND

Outdoor navigation is widely deployed thanks to the development of various global-navigation-satellite-systems (GNSS), e.g., Global Positioning System (GPS), GALILEO, and the like.

A GNSS device may be equipped with a GNSS receiver to receive GNSS signals from one or more GNSS transmitters.

A GNSS cellular device may have cellular connectivity to a cellular network, which may enable the GNSS cellular device to interact with a remote location server to receive assistance data. The assistance data may be utilized, for example, to improve performance of the GNSS cellular device, such as reducing time to first fix, better accuracy, better satellite reception sensitivity, and the like.

The GNSS cellular device may support various advanced services, functionalities and/or use cases, such as, a mobile originate location request, a mobile terminated location request, an emergency position reporting (E-911), GEO-fencing, GEO-logging, GEO-caching, periodic reporting, and more.

Some GNSS devices (“GNSS cellular-less devices”) may lack or may not be able to support cellular connectivity. For example, many mobile computing devices, e.g., a tablet computer, wearable devices, “Internet of things” (IOT) devices, and the like, may support GNSS and non-cellular wireless connectivity, while lacking support of cellular connectivity.

As a result, the GNSS cellular-less devices may be limited to GNSS autonomous functionality, e.g., performing GNSS positioning operations, without interaction with the cellular network, without ability to receive the assistance data, and without supporting the advanced use cases.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic deployment of a system, in accordance with some demonstrative embodiments.

FIG. 3 is a schematic sequence diagram of operations and interactions between a portable device, a cellular device, and a remote location server, in accordance with some demonstrative embodiments.

FIG. 4 is a schematic sequence diagram of operations and interactions between a portable device, a cellular device, and a remote location server, in accordance with some demonstrative embodiments.

FIG. 5 is a schematic flow chart illustration of a method of communicating assisted global navigation satellite system (A-GNSS) information, in accordance with some demonstrative embodiments.

FIG. 6 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), an Internet of Things (IoT) device, a wearable device, a User Equipment (UE), a desktop computer, an Ultrabook™, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11 task group ac (TGac) (“IEEE802.11-09/0308r12—TGac Channel Model Addendum Document”); IEEE 802.11 task group ad (TGad) (IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec., 2012)) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Open Mobile Alliance (OMA) standards, including the Secure User Plane Location (SUPL) protocol (SUPL-OMA-AD-SUPL-V2.0), the Mobile Location Protocol (MLP) (OMA-TS-MLP v 3.3, March 2009), the LTE Positioning Protocol (LPP) Extensions (OMA-TS-LPPe-V1_0-20130319-C), the User Plane Location Protocol (OMA-TS-ULP-V3_0-20110920-C) and/or future versions and/or derivatives thereof, devices and/or networks operating in accordance with existing In Location Alliance protocols and/or standards and/or future versions and/or derivatives thereof, devices and/or networks operating in accordance with existing World-Wide-Web Consortium (W3C) standards, including the W3C Hypertext Markup Language (HTML) Version 5, October 2010 and/or future versions and/or derivatives thereof, devices and/or networks operating in accordance with existing WirelessHD™ specifications and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a radio, which is capable of communicating a wireless communication signal, may include a wireless transmitter to transmit the wireless communication signal to at least one other radio, and/or a wireless communication receiver to receive the wireless communication signal from at least one other radio. The verb “communicating” may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN. Other embodiments may be used in conjunction with any other suitable wireless communication network, for example, a wireless area network, a “piconet”, a WPAN, a WVAN and the like.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmWave) frequency band), e.g., a frequency band within the frequency band of between 20 Ghz and 300 GHZ, a WLAN frequency band, a WPAN frequency band, a frequency band according to the WGA specification, and the like.

Some demonstrative embodiments are described herein with respect to a 3G cellular network. However, other embodiments may be implemented in any other suitable cellular network, e.g., a LTE cellular network, a 4G cellular network, a 5G cellular network, a WiMax cellular network, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

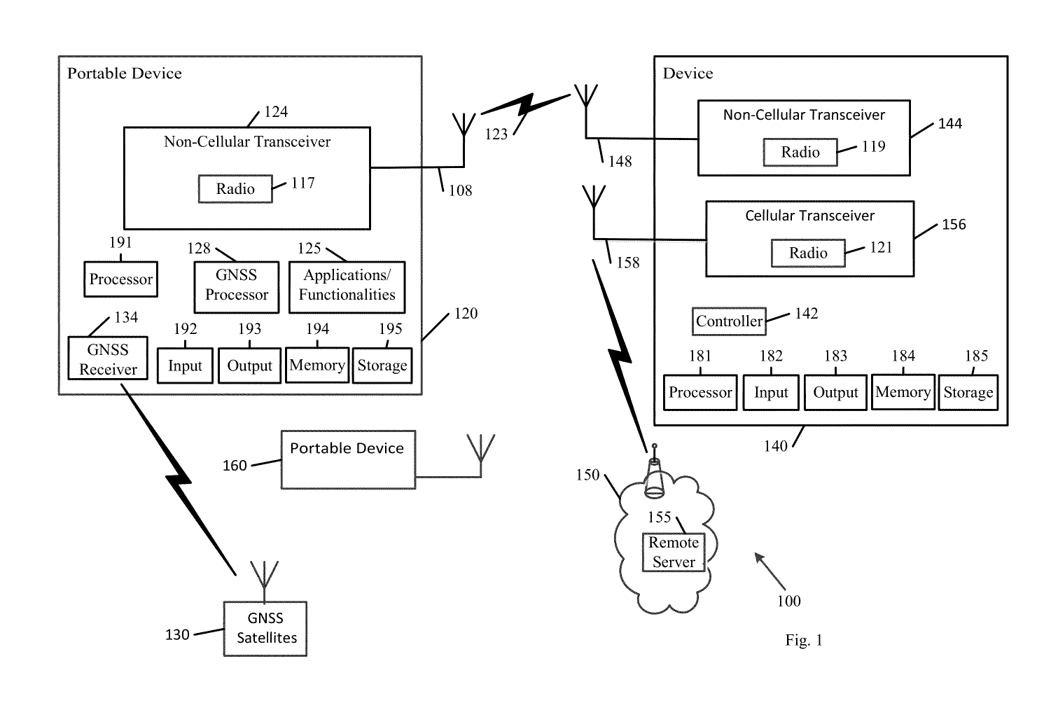

Reference is now made to FIG. 1, which schematically illustrates a block diagram of a system 100, in accordance with some demonstrative embodiments.

As shown in FIG. 1, in some demonstrative embodiments, system 100 may include one or more wireless communication devices capable of communicating content, data, information and/or signals via a wireless medium (WM). For example, system 100 may include a wireless communication device 120, a wireless communication device 140, and/or a wireless communication device 160.

In some demonstrative embodiments, the wireless medium may include, for example, a radio channel, a cellular channel, an RF channel, a Wireless Fidelity (WiFi) channel, an IR channel, a Bluetooth (BT) channel and the like. One or more elements of system 100 may optionally be capable of communicating over any suitable wired communication links.

In some demonstrative embodiments, system 100 may include a cellular device and one or more portable devices. For example, wireless communication device 140 may include a cellular device and/or wireless communication devices 120 and/or 160 may include a portable device.

In some demonstrative embodiments, cellular device 140 may include, for example, a Smartphone, a mobile phone, a vehicular phone, a cellular phone, a computing device, a User Equipment (UE), or any other device having cellular connectivity capabilities.

In some demonstrative embodiments, portable device 120 and/or portable device 160 may include a cellular-less device, e.g., a portable device not having cellular connectivity capabilities.

In some demonstrative embodiments, portable device 120 and/or portable device 160 may include, for example, a mobile computer, a laptop computer, a notebook computer, a tablet computer, an Ultrabook™ computer, a mobile internet device, a portable computer, a wearable device, an Internet of Things (IoT) device, a handheld computer, a handheld device, a PDA device, a handheld PDA device, an on-board device, an off-board device, a consumer device, a vehicular device, a non-vehicular device, a portable device, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a video device, an audio device, an A/V device, a gaming device, a media player, or the like.

In some demonstrative embodiments, portable device 120 and/or portable device 160 may also include, for example, a processor 191, an input unit 192, an output unit 193, a memory unit 194, and a storage unit 195; and/or cellular device 140 may also include, for example, a processor 181, an input unit 182, an output unit 183, a memory unit 184, and a storage unit 185. Portable device 120, portable device 160, and/or cellular device 140 may optionally include other suitable hardware components and/or software components. In some demonstrative embodiments, some or all of the components of portable device 120, portable device 160, and/or cellular device 140 may be enclosed in a common housing or packaging, and may be interconnected or operably associated using one or more wired or wireless links. In other embodiments, components of portable device 120, portable device 160, and/or cellular device 140 may be distributed among multiple or separate devices.

Processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. For example, processor 191 executes instructions, for example, of an Operating System (OS) of portable device 120 and/or of one or more suitable applications. Processor 181 may execute instructions, for example, of an Operating System (OS) of cellular device 140 and/or of one or more suitable applications.

Memory unit 194 and/or memory unit 184 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. For example, memory unit 194 and/or storage unit 195, for example, may store data processed by portable device 120. Memory unit 184 and/or storage unit 185, for example, may store data processed by cellular device 140.

Input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Cathode Ray Tube (CRT) display unit, a Liquid Crystal Display (LCD) display unit, a plasma display unit, one or more audio speakers or earphones, or other suitable output devices.

In some demonstrative embodiments, portable device 120, portable device 160, and/or cellular device 140 may include one or more transceivers to perform communication between portable device 120, portable device 160, cellular device 140 and/or any other wireless communication devices.

In some demonstrative embodiments, portable device 120 and/or portable device 160 may include a non-cellular communication transceiver 124 to communicate with one or more devices via a non-cellular network.

In some demonstrative embodiments, cellular device 140 may include a non-cellular communication transceiver 144 to communicate over the non-cellular network, for example, with cellular-less devices, e.g., portable device 120.

In some demonstrative embodiments, non-cellular communication transceivers 124 and/or 144 may include, for example, a BT transceiver, a WiFi transceiver and/or any other non-cellular transceiver.

In some demonstrative embodiments, non-cellular communication transceiver 144 may include a broadcast transceiver, for example, a Frequency Modulation Radio (FMR), or a Digital Broadcast Radio (DBR).

In some demonstrative embodiments, cellular device 140 may include a cellular communication transceiver 156 to communicate with a cellular network 150. For example, cellular communication transceiver 156 may include a 3G transceiver, an LTE transceiver, an EDGE transceiver, and/or any other cellular communication transceiver. Additionally or alternatively, cellular device 140 may connect to cellular network 150 via any other suitable mechanisms, e.g. Wi-Fi for SUPL over Wi-Fi services.

For example, In some demonstrative embodiments, cellular network 150 may include a Global System for Mobile (GSM) network, a Universal Mobile Telecommunications System (UMTS) network, a Long Term Evolution (LTE) network, an LTE-advanced network, a Fifth Generation (5G) network, or any other network.

In some demonstrative embodiments, transceivers 124, 144 and/or 156 may include one or more radios. For example, transceiver 124 may include at least one radio 117, transceiver 144 may include at least one radio 119, and/or transceiver 156 may include at least one radio 121. Radios 117, 119 and/or 121 may include one or more wireless transmitters, receivers and/or transceivers able to send and/or receive wireless communication signals, RF signals, frames, blocks, transmission streams, packets, messages, data items, and/or data. In one example, radios 117, 119 and/or 121 may include modulation elements, demodulation elements, amplifiers, analog to digital and digital to analog converters, filters, and/or the like. For example, transceivers 124, 144 and/or 156 may include or may be implemented as part of a wireless Network Interface Card (NIC), and the like.

In some demonstrative embodiments, transceivers 124, 144 and/or 156 may include, or may be associated with, one or more antennas. For example, transceiver 124 may be associated with one or more antennas 108, transceiver 144 may be associated with one or more antennas 148, and/or transceiver 156 may be associated with one or more antennas 158.

Antennas 108, 148 and/or 158 may include any type of antennas suitable for transmitting and/or receiving wireless communication signals, blocks, frames, transmission streams, packets, messages and/or data. For example, antennas 108, 148 and/or 158 may include any suitable configuration, structure and/or arrangement of one or more antenna elements, components, units, assemblies and/or arrays. Antennas 108, 148 and/or 158 may include, for example, antennas suitable for directional communication, e.g., using beamforming techniques. For example, antennas 108, 148 and/or 158 may include a phased array antenna, a multiple element antenna, a set of switched beam antennas, and/or the like. In some embodiments, antennas 108, 148 and/or 158 may implement transmit and receive functionalities using separate transmit and receive antenna elements. In some embodiments, antennas 108, 148 and/or 158 may implement transmit and receive functionalities using common and/or integrated transmit/receive elements.

In some demonstrative embodiments, antennas 148 and 158 may be implemented as separate antennas. In other embodiments, antennas 148 and 158 may be implemented as a common antenna. For example, antennas 148 and 158 may be implemented as a hybrid antenna having cellular capabilities and non-cellular capabilities.

In some demonstrative embodiments, portable device 120, portable device 160, and/or cellular device 140 may be located in close proximity to one another.

In one example, portable device 120 may include an IoT device, e.g., a wrist Internet watch, and/or cellular device 140 may include a Smartphone. According to this example, portable device 120 may be worn on a hand of a user, and cellular device 140 may be held or carried by the user.

In another example, portable device 160 may include a vehicular GPS device and/or cellular device 140 may include a vehicular phone. According to this example, the vehicular phone and the vehicular GPS device may be both mounted on a dashboard of a car.

In another example, portable device 120 may include a tablet computer, portable device 160 may include a wrist Internet watch, and/or cellular device 140 may include a mobile phone. According to this example, a user of portable device 120, portable device 160, and/or cellular device 140 may carry both the tablet and the mobile phone and may wear the wrist Internet watch on her hand.

In some demonstrative embodiments, portable device 120 may include a Global-Navigation-Satellite-System (GNSS) receiver 134 to receive GNSS information from a plurality of GNSS satellites 130.

In some demonstrative embodiments, portable device 120 may utilize the GNSS information, for example, to estimate a location of portable device 120.

In some demonstrative embodiments, portable device 120 may utilize the GNSS information, for example, to produce data for estimating the location of portable device 120, e.g., by a remote location server 155. For example, portable device 120 may utilize the GNSS information to produce time information and/or orbital information of GNSS satellites 130, which may be utilized, e.g., by a remote location server 155, to estimate the location of portable device 120.

In some demonstrative embodiments, cellular communication transceiver 156 may receive from remote location server 155, e.g., via cellular network 150, Assisted Global-Navigation-Satellite-System (A-GNSS) information.

In some demonstrative embodiments, cellular device 140 may be capable of receiving the A-GNSS information, for example, if cellular device 140 includes cellular communication transceiver 156 and/or if cellular device 140 is registered in cellular network 150, for example, if cellular device is assigned with an identity in cellular network 150, e.g., an International Mobile Subscriber Identity (IMSI), and/or an Mobile Subscriber Integrated Services Digital Network-Number (MSISDN).

In some demonstrative embodiments, the A-GNSS information may include, for example, orbital data, e.g., ephemeris, of GNSS satellites 130, almanac data of GNSS satellites 130, an accurate time, ionospheric conditions and/or any other data relating to GNSS satellites 130 and/or signals from GNSS satellites 130.

In some demonstrative embodiments, a portable device using the A-GNSS information may improve performance of the portable device. For example, the A-GNSS information may enable reducing time to determine a first FIX location of the portable device, reducing time to acquire one or more satellites of GNSS satellites 130, increasing an accuracy of the FIX location, and/or improving satellites reception sensitivity of the signals from GNSS satellites 130.

In some demonstrative embodiments, a cellular-less device may not be able to receive the A-GNSS information directly from cellular network 150, for example, since the cellular-less device may not have a direct connection to cellular network 150, the cellular-less device may not be registered in cellular network 150.

In some demonstrative embodiments, the cellular-less device may be limited to GNSS autonomous use cases, e.g., producing a position report without the A-GNSS information. Accordingly, the performance of the cellular-less device may be reduced, e.g., with respect to time to first fix, sensitivity, and the like. Additionally, the cellular-less may not be able to support advanced use cases, e.g., E-911, MTLR, periodic report, geo-fencing, remaining hot start, and the like.

Some demonstrative embodiments may enable enhanced A-GNSS functionalities and capabilities for cellular-less devices, e.g., as described below.

Some demonstrative embodiments, may enable enhanced A-GNSS functionalities and capabilities of an A-GNSS stack, e.g., as described below.

Some demonstrative embodiments may enhance A-GNSS functionalities and capabilities of cellular devices that include an A-GNSS stack, e.g., as described below.

Some demonstrative embodiments may enable adding A-GNSS functionalities and capabilities to cellular-less devices, e.g., wearable devices, and/or “Internet of things” devices, e.g., as described below.

Some demonstrative embodiments may be implemented to provide an extension to portable device 120 to enable portable device 120 to utilize A-GNSS functionality of an A-GNSS framework, which may be separate from portable device 120, e.g., as described below.

In some demonstrative embodiments, cellular device 140 and portable device 120 may be configured to enable cellular device 140 to provide cellular connectivity, for example, A-GNSS connectivity, to portable device 120, e.g., as described below.

Some demonstrative embodiments may enable supporting advanced GNSS functionality by portable device 120.

In some demonstrative embodiments, portable device 120 may use a communication interface with cellular device 140 to enable the A-GNSS connectivity via cellular device 140. The A-GNNS connectivity via cellular device 140 may enable portable device 120 to become a full A-GNSS device in a “combined” manner.

In some demonstrative embodiments, cellular device 140 may use an A-GNSS Software (SW) stack and identifications, e.g., the IMSI and the MSISDN of cellular device 140, to register with cellular network 150, and to use the services provided by remote location server 155.

In some demonstrative embodiments, a core functionality of portable device 120 may be separate from the A-GNSS SW stack of cellular device 140. In some demonstrative embodiments, cellular device 140 may expose the A-GNSS SW stack to portable device 120 over a non-cellular interface between portable device 120 and cellular device 140, e.g., as described below.

In some demonstrative embodiments, cellular device 140 may be configured to perform the functionality of a central cellular device (“serving device”) to communicate with one or more non-cellular devices, for example, portable devices 120 and 160, via a personal area network (PAN), e.g., a BT network.

In some demonstrative embodiments, cellular device 140 may be configured to serve portable device 120 via peer-to-peer connectivity, and/or to broadcast data, e.g., the A-GNSS information, to be received by a plurality of non-cellular devices.

In some demonstrative embodiments, centralized cellular A-GNSS services may be provided by a public or a private connectivity infrastructure, for example, WiFi access points, e.g., including cellular device 140, which may be configured to connect to cellular network 150, and to deliver assistance services to one or more clients, e.g., portable devices 120 and 160, in a wide area, e.g., a Wide Area Network or a Metropolitan Area Network.

In some demonstrative embodiments, portable device 120 may be able to search for, to connect to, and to use the external A-GNSS services, via the connection with cellular device 140, e.g., as described below.

Some demonstrative embodiments may enable portable device 120 to receive the A-GNSS information from cellular network 150 via cellular device 140, and to utilize the A-GNSS information to improve performance of portable device 120, e.g., as described below.

In some demonstrative embodiments, portable device 120 may be able to receive the A-GNSS information from cellular network 150 via cellular device 140, for example, if cellular device 140 and portable device 120 are in close proximity to one another, e.g., as described above.

In some demonstrative embodiments, cellular device 140 may include a controller 142 configured to control the functionality of cellular transceiver 156 and/or non-cellular transceiver 144. For example, controller 142 may be configured to transfer the A-GNSS information from transceiver 156 to transceiver 144, and/or to convert the A-GNSS information into a format suitable for transmission by transceiver 144.

In some demonstrative embodiments, cellular transceiver 156 may receive the A-GNSS information from remote location server 155 via cellular network 150.

In some demonstrative embodiments, controller 142 may be configured to control non-cellular transceiver 144 to transmit the A-GNSS information to at least one portable device over a non-cellular network.

For example, controller 142 may control non-cellular transceiver 144 to transmit the A-GNSS information to portable device 120 over the non-cellular network.

In some demonstrative embodiments, non-cellular transceiver 124 may receive the A-GNSS information from cellular device 140 via the non-cellular network.

In some demonstrative embodiments, non-cellular transceivers 124 and/or 144 may establish a connection between portable device 120 and cellular device 140 to enable portable device 120 to receive the A-GNSS information from cellular device 140.

In some demonstrative embodiments, the connection between portable device 120 and cellular device 120 may include an encrypted connection, an authenticated connection, a secured connection, an open connection, and/or any other type of connection.

In some demonstrative embodiments, non-cellular transceivers 124 and/or 144 may communicate via a personal area network (PAN) 123.

In one example, non-cellular transceivers 124 and/or 144 may be able to communicate via PAN 123, for example, if portable device 120 and cellular device 140 are located in proximity one to another, e.g., as described above.

In some demonstrative embodiments, PAN 123 may include a wireless PAN.

In some demonstrative embodiments, wireless PAN 123 may include a Wi-Fi network, or a Peer to-Peer (P2P) network, for example, if non-cellular transceivers 124 and/or 144 include a WiFi transceiver.

In some demonstrative embodiments, wireless PAN 123 may include a BT network, for example, if non-cellular transceivers 124 and/or 144 include a BT transceiver. In other embodiments, the wireless PAN 123 may include any other wireless network.

In one example, portable device 120 may include a tablet computer and/or cellular device 140 may include a Smartphone, both carried by a user. According to this example, the Smartphone may receive the A-GNSS information from server 155 via cellular network 150, and the Smartphone may transmit the A-GNSS information to the tablet computer, for example, via a BT connection and/or a WiFi connection between the tablet computer and the Smartphone.

In some demonstrative embodiments, PAN 123 may include a wired PAN, e.g., a USB link.

In one example, portable device 120 may include a vehicular GPS device and/or cellular device 140 may include a vehicular phone both mounted on a dashboard of a car. According to this example, the vehicular device may be connected to the vehicular phone with a data wire, e.g., a USB cable, and may receive the A-GNSS information from the vehicular phone via the data wire.

In some demonstrative embodiments, controller 142 may be configured to control non-cellular transceiver 144 to broadcast the A-GNSS information over the non-cellular network. For example, non-cellular transceiver 144 may broadcast the A-GNSS information over the non-cellular network, which may enable portable devices 120 and/or 160 to receive the A-GNSS information.

In one example, non-cellular transceiver 144 may broadcast the A-GNSS information, for example, as a WiFi broadcast transmission, e.g., if non-cellular transceiver 144 includes a WiFi transceiver, e.g., an Access Point (AP).

In another example, non-cellular transceiver 144 may broadcast the A-GNSS information as a radio broadcast transmission, for example, to enable broadcasting the A-GNSS information to a relatively wide coverage area, e.g., if non-cellular transceiver includes an FMR or a DBR.

In some demonstrative embodiments, non-cellular transceiver 124 may receive the A-GNSS information from cellular device 140.

In some demonstrative embodiments, portable device 120 may include a GNSS processor 128, for example, to process the GNSS information, e.g., received from satellites 130.

In some demonstrative embodiments, GNSS processor 128 may process the GNSS information based on the A-GNSS information.

In some demonstrative embodiments, GNSS processor 128 may process the GNSS information based on the A-GNSS information, for example, to estimate the location of portable device 120.

In some demonstrative embodiments, GNSS processor 128 may process the GNSS information based on the A-GNSS information, for example, to produce GNSS data to be utilized by a local application running on portable device 120, or by a remote device, e.g., remote location server 150.

In one example, GNSS processor 128 may produce timing information and/or orbital information of satellites 130 based on the GNSS information and/or the A-GNSS information. According to this example, remote location server 155 may estimate the location of portable device 120 based on the timing information and/or the orbital information produced by portable device 120.

In some demonstrative embodiments, portable device 120 may include one or more applications and/or functionalities 125, which may be configured to utilize information of the location of portable device 120.

In some demonstrative embodiments, applications and/or functionalities 125 may include a mobile originate location request, a mobile terminated location request, an emergency position reporting (E-911), a Geo-reference (GEO) fencing, a GEO-logging, a Geo-caching, a periodic reporting, and or any other application/functionality utilizing the location information corresponding to the location of portable device 120.

In some demonstrative embodiments, GNSS processor 128 may process the A-GNSS information in response to a request from applications and/or functionalities 125. For example, GNSS processor 128 may process the A-GNSS information in response to a request from the mobile originate location request, the mobile terminated location request, the emergency position reporting, the Geo-reference (GEO) fencing, the GEO-logging, the Geo-caching, and the periodic reporting.

In some demonstrative embodiments, utilizing the GNSS information and the A-GNSS information may improve performance of GNSS processor 128. For example, GNSS processor 128 may utilize the A-GNSS information to determine a first FIX location of portable device 120 at a reduced time.

In one example, portable device 120 may utilize the GNSS information and the A-GNSS information to enable GNSS processor 128 to produce an emergency position reporting at a short period of time, for example, compared to a period of time to produce an emergency position reporting, if the A-GNSS information is not utilized.

In some demonstrative embodiments, portable device 120 may be configured to send the A-GNSS information to one or more other portable devices. For example, portable device 120 may be configured to send the A-GNSS information to portable device 160.

In some demonstrative embodiments, non-cellular transceiver 124 may be configured to send the A-GNSS information to portable device 160.

In some demonstrative embodiments, non-cellular transceiver 124 may be configured to broadcast the A-GNSS information.

In one example, portable device 120 may include a tablet computer, portable device 160 may include a bracelet having Internet connectivity, and cellular device 140 may include a Smartphone. According to this example, the Smartphone may receive A-GNSS information from cellular network 150, and the Smartphone may transmit the A-GNSS information to the tablet computer. The tablet computer may transmit the A-GNSS information to the bracelet, or may broadcast. Accordingly, both the tablet computer and the bracelet may utilize the A-GNSS information provided by the Smartphone.

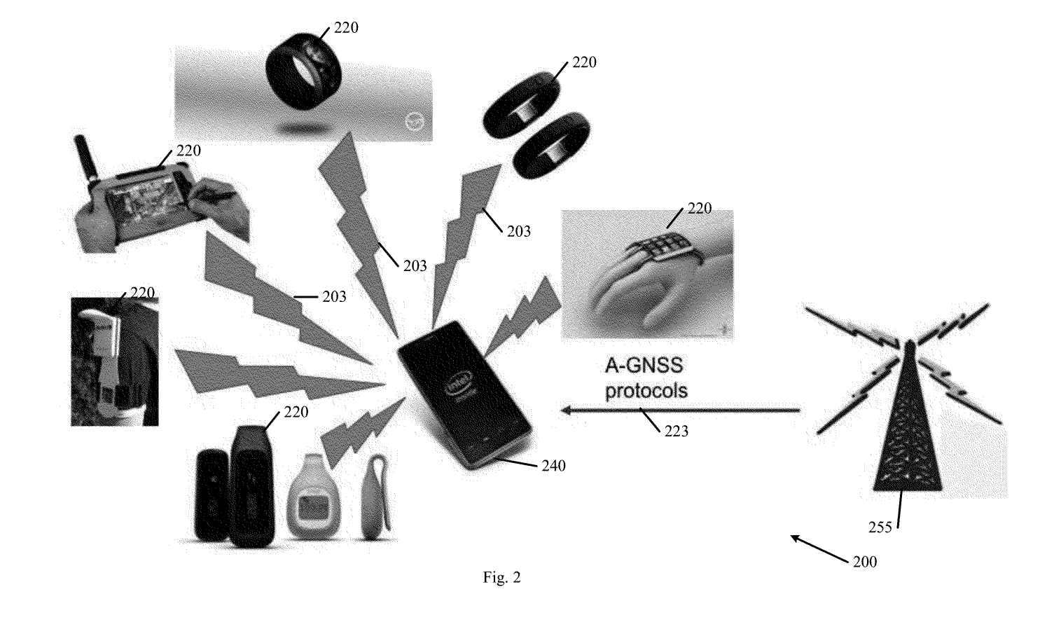

Reference is made to FIG. 2, which schematically illustrates a deployment of a system 200, in accordance with some demonstrative embodiments. For example, system 200 may perform the functionality of system 100 (FIG. 1).

As shown in FIG. 2, system 200 may include a Smartphone 240 connected to cellular network 255 via A-GNSS protocols 223. For example, Smartphone 240 may perform the functionality of cellular device 140 (FIG. 1).

As shown in FIG. 2, a plurality of cellular-less devices 220, e.g., wearable devices, IoT devices and the like, may be connected to Smartphone 240 via a non-cellular network 203 to receive A-GNSS information from Smartphone 240.

In some demonstrative embodiments, Smartphone 240 may transmit the A-GNSS information to cellular-less devices 220. In other embodiments, Smartphone 240 may broadcast the A-GNSS information, which may enable cellular-less devices 220 to receive the A-GNSS information.

Referring back to FIG. 1, in some demonstrative embodiments portable device 120 may initiate the connection between portable device 120 and cellular device 140, e.g., to enable portable device 120 to receive the A-GNSS information from cellular device 140.

In some demonstrative embodiments, portable device 120 may initiate the connection between portable device 120 and cellular device 140, for example, if applications and/or functionalities 125 request the A-GNSS information.

In one example, portable device 120 may initiate the connection between portable device 120 and cellular device 140, for example, in response to a geo fencing service request for A-GNSS information, e.g., to determine if the user of portable device 120 is within boundaries specified by the geo fencing service.

In some demonstrative embodiments, GNSS processor 128 may request the A-GNSS information from cellular device 140.

In some demonstrative embodiments, GNSS processor 128 may control non-cellular communication transceiver 124 to send an assistance request to cellular device 140.

In some demonstrative embodiments, non-cellular communication transceiver 144 may receive the assistance request from portable device 120 via the non-cellular network.

In some demonstrative embodiments, controller 142 may receive the assistance request, and may control non-cellular communication transceiver 144 to transmit to portable device 120 the A-GNSS information, e.g., in response to the assistance request.

In some demonstrative embodiments, non-cellular communication transceiver 124 may receive the A-GNSS information, and GNSS processor 128 may utilize the A-GNSS information, for example, to estimate the location of portable device 120.

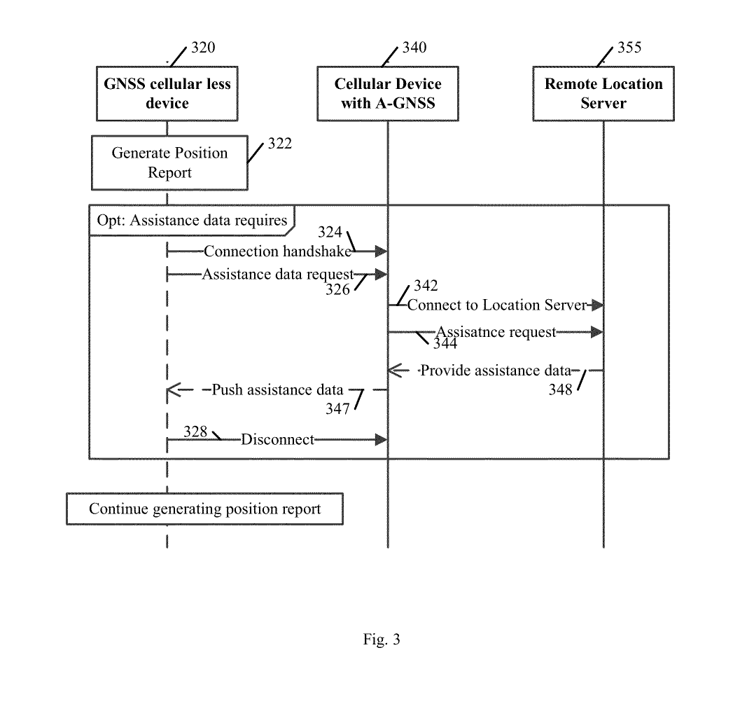

Reference is made to FIG. 3, which schematically illustrates a sequence diagram 300 of operations and interactions between a portable device 320, a cellular device 340 and a remote location server 355, in accordance with some demonstrative embodiments. For example, portable device 320 may perform the functionality of mobile device 120 (FIG. 1), cellular device 340 may perform the functionality of cellular device 140 (FIG. 1), and/or remote location server 355 may perform the functionality of remote location server 155 (FIG. 1).

In some demonstrative embodiments, one or more of the operations of sequence diagram 300 may be performed as part of a request for assistance data initiated by a cellular-less device, e.g., portable device 120.

As shown in FIG. 3, portable device 320 may try to produce a position report 322, which may require portable device 320 to receive assistance data. For example, one or more of applications/functionalities 125 (FIG. 1) of portable device 120 (FIG. 1) may request GNSS processor 128 (FIG. 1) to produce a position report, e.g., as described above.

As shown in FIG. 3, portable device 320 may connect (324) to cellular device 340, and may send to cellular device 340 a request 326 for the assistance data. For example, portable device 120 (FIG. 1) may connect to cellular device 140 (FIG. 1) and may send the assistance request to cellular device 140 (FIG. 1), e.g., as described above.

As shown in FIG. 3, cellular device 340 may connect (342) to remote location server 355, and may request (344) the assistance data, for example, as a cellular Network (NW) subscriber. For example, cellular device 140 (FIG. 1) may connect to server 155 (FIG. 1) to retrieve the A-GNSS information, e.g., as described above.

As shown in FIG. 3, server 355 may provide (346) the assistance data to cellular device 340, and cellular device 340 may receive the assistance date from remote location server 355. For example, cellular device 140 (FIG. 1) may receive the A-GNSS information from server 155 (FIG. 1), e.g., as described below.

As shown in FIG. 3, cellular device 340 may forward (347) the assistance data to portable device 320. For example, cellular device 140 (FIG. 1) may send the A-GNSS information to portable device 120 (FIG. 1), for example, via the non-cellular network, e.g., as described above.

In some demonstrative embodiments, portable device 320 may utilize the assistance data, for example, to estimate the location of portable device 320. For example, portable device 120 (FIG. 1) may process the A-GNSS information, for example, to estimate the location of portable device 120 (FIG. 1), e.g., as described above.

As shown in FIG. 3, portable device 320 may disconnect (328) from cellular device 340, for example, if no additional A-GNSS information is required.

Referring back to FIG. 1, in some demonstrative embodiments, cellular device 140 may initiate the connection between portable device 120 and cellular device 140, for example, to enable portable device 120 to receive the A-GNSS information from cellular device 140.

In some demonstrative embodiments, cellular device 140 may initiate the connection between portable device 120 and cellular device 140, for example, if a remote server, a remote user and/or a remote device requests a location report from portable device 120.

In some demonstrative embodiments, cellular device 140 may initiate the connection between portable device 120 and cellular device 140, for example, in response to a network induced (NI) location request, e.g., from server 155, the remote user, and the like.

In one example, cellular device 140 may initiate the connection between portable device 120 and cellular device 140. For example, server 155 may request an emergency position reporting to determine the location of the user of portable device 120, e.g., in case of an emergency, for example, if the user of portable device 120 is missing.

In some demonstrative embodiments, non-cellular communication transceiver 144 may transmit to portable device 120 a location request.

In some demonstrative embodiments, non-cellular communication transceiver 124 may receive the location request from cellular device 140.

In some demonstrative embodiments, GNSS processor 128 may estimate the location of portable device 120 based on the GNSS information and the A-GNSS information.

In some demonstrative embodiments, non-cellular communication transceiver 124 may transmit to cellular device 140, in response to the location request, a position report including the estimated location of portable device 120.

In some demonstrative embodiments, cellular device 140 may receive the position report, and cellular transmitter 156 may send the position report, for example, to server 155, e.g., via cellular network 150.

In some demonstrative embodiments, non-cellular communication transceiver 144 may transmit to portable device 120 a location request notification, for example, via the non-cellular network.

In some demonstrative embodiments, non-cellular communication transceiver 124 may receive the location request notification from cellular device 140, for example, via the non-cellular network.

In some demonstrative embodiments, non-cellular communication transceiver 124 may send a location request verification to cellular device 140, for example, in response to the location request notification.

In some demonstrative embodiments, non-cellular communication transceiver 144 may receive the location request verification from portable device 120.

In some demonstrative embodiments, non-cellular communication transceiver 144 may transmit the location request after receipt of the location request verification from portable device 120.

In some demonstrative embodiments, non-cellular communication transceiver 124 may receive the location request after sending the location request verification to cellular device 140.

In some demonstrative embodiments, the location request may include a Mobile Terminal Location Request (MTLR).

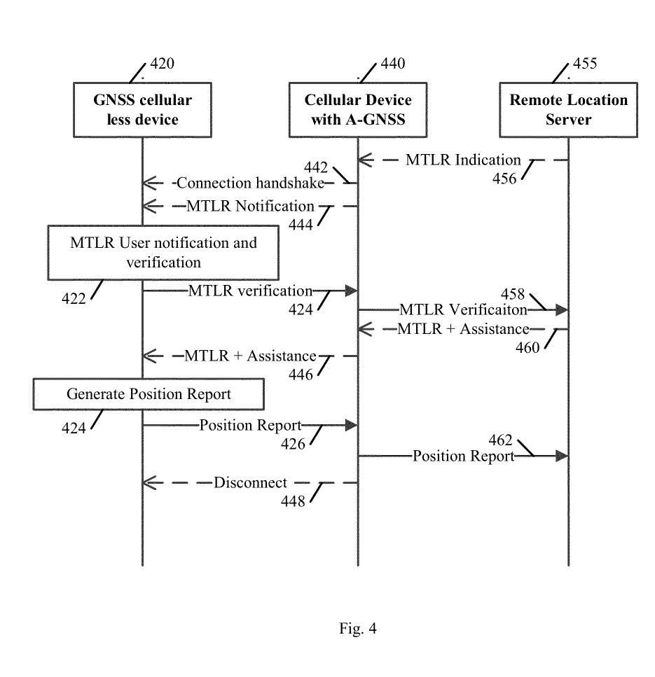

Reference is made to FIG. 4, which schematically illustrates a sequence diagram 400 of operations and interactions between a portable device 420, a cellular device 440 and a remote location server 455, in accordance with some demonstrative embodiments. For example, portable device 420 may perform the functionality of mobile device 120 (FIG. 1), cellular device 440 may perform the functionality of cellular device 140 (FIG. 1) and/or remote location server 455 may perform the functionality of remote location server 155 (FIG. 1).

In some demonstrative embodiments, one or more of the operations of sequence diagram 400 may be performed as part of a network-initiated request for location report, in accordance with some demonstrative embodiments.

As shown in FIG. 4, remote location server 455 may send a notification 456 to cellular device 440 to notify cellular device 400 of a Mobile-Terminated request for location report from portable device 420.

In some demonstrative embodiments, remote location server 455 may label the notification 456 as aimed for portable device 420. In other embodiments, remote location server 455 may not label notification 456 as aimed for portable device 420. For example, cellular device 440 may utilize an internal logic to determine to forward the notification 456 to portable device 420.

As shown in FIG. 4, cellular device 440 may connect (442) to portable device 420, and may send (444) notification 456 to portable device 420. For example, non-cellular communication transceiver 144 (FIG. 1) may transmit the location request notification to portable device 120 (FIG. 1).

In some demonstrative embodiments, portable device 420 may receive notification 456 and may determine whether or not to confirm the Mobile-Terminated request for location report. For example, portable device 420 may prompt a user of mobile device to verify or reject the request. Alternatively, portable device 420 may automatically determine whether to verify or reject the request, e.g., based on predefined criteria.

As shown in FIG. 4, portable device 420 may verify (422) notification 456, and may send a verification 446 to cellular device 440, for example, if portable device 420 confirms the Mobile-Terminated request. For example, non-cellular communication transceiver 124 (FIG. 1) may send the location request verification to cellular device 140 (FIG. 1).

As shown in FIG. 4, cellular device 440 may receive verification 424, and may forward (458) verification 424 to remote location server 455.

As shown in FIG. 4, remote location server 455 may send cellular device 440 a request 460 for a location report, e.g., utilizing a predefined MTLR procedure. Request 460 may include A-GNSS information to assist in determining the location report.

As shown in FIG. 4, cellular device 440 may receive request 460, and may push (446) request 446 including the A-GNSS data to portable device 420.

As shown in FIG. 4, portable device 420 may receive request 446 including the A-GNSS data, and may produce a location report 424. For example, non-cellular communication transceiver 124 (FIG. 1) may receive the location request from cellular device 140 (FIG. 1), and GNSS processor 128 (FIG. 1) may estimate the location of portable device 120 (FIG. 1) based on the GNSS information from GNSS receiver 134 (FIG. 1), and the A-GNSS information received from cellular device 140 (FIG. 1).

As shown in FIG. 4, portable device 420 may send (426) location report 424 to cellular device 440. For example, non-cellular communication transceiver 124 (FIG. 1) may transmit to cellular device 140 (FIG. 1) the position report including the estimated location of portable device 120 (FIG. 1).

As shown in FIG. 4, cellular device 440 may receive location report 424, and may forward (462) location report 424 to remote location server 455. For example cellular transmitter 156 may receive the position report from portable device 120 (FIG. 1), and may send the position report, for example, to server 155, via cellular network 150.

In some demonstrative embodiments, remote location server 455 may utilize location report 424, for example, to estimate the location of portable device 420, e.g., in case of an emergency.

As shown in FIG. 4, cellular device 440 may disconnect (448) from portable device 420, for example, if no additional information is required from portable device 420.

Referring back to FIG. 1, in some demonstrative embodiments, cellular device 140 may be configured to announce and/or to indicate to one or more other devices, e.g., portable devices 120 and/or 160, of a capability (“the A-GNSS forwarding capability”) of cellular device 140 to receive the A-GNSS information from cellular network 150, and to forward the A-GNSS information to the one or more other devices via the non-cellular network. For example, cellular device 140 may utilize an information element (IE) of a broadcast frame, e.g., a beacon, a probe request or the like, to announce the A-GNSS forwarding capability.

In some demonstrative embodiments, portable device 120 may be configured to announce and/or to indicate to one or more cellular devices, e.g., cellular device 140, of a capability (“the A-GNSS processing capability”) of portable device 120 to receive the A-GNSS information via the non-cellular network, and to utilize the A-GNSS information. For example, portable device 120 an information element (IE) of a broadcast frame, e.g., a beacon, a probe request or the like, to announce the A-GNSS processing capability.

In some demonstrative embodiments, communicating the A-GNSS information via the non-cellular network may enable enhanced A-GNSS functionalities and capabilities for non-cellular devices, e.g., portable devices 120 and/or 160.

In some demonstrative embodiments, communicating the A-GNSS information via the non-cellular network may enable enhanced A-GNSS functionalities and capabilities of an A-GNSS stack. For example, cellular device 140 may perform the functionality of an A-GNSS stack for portable devices 120 and/or 160.

In some demonstrative embodiments, communicating the A-GNSS information via the non-cellular network may enable adding A-GNSS functionalities and capabilities to non-cellular devices, e.g., wearable devices and/or “Internet of things” devices. For example, portable device 160 and/or portable device 120 may be capable of utilizing the A-GNSS functionalities and capabilities, e.g., even if portable device 160 and/or portable device 160 do not have a cellular connectivity.

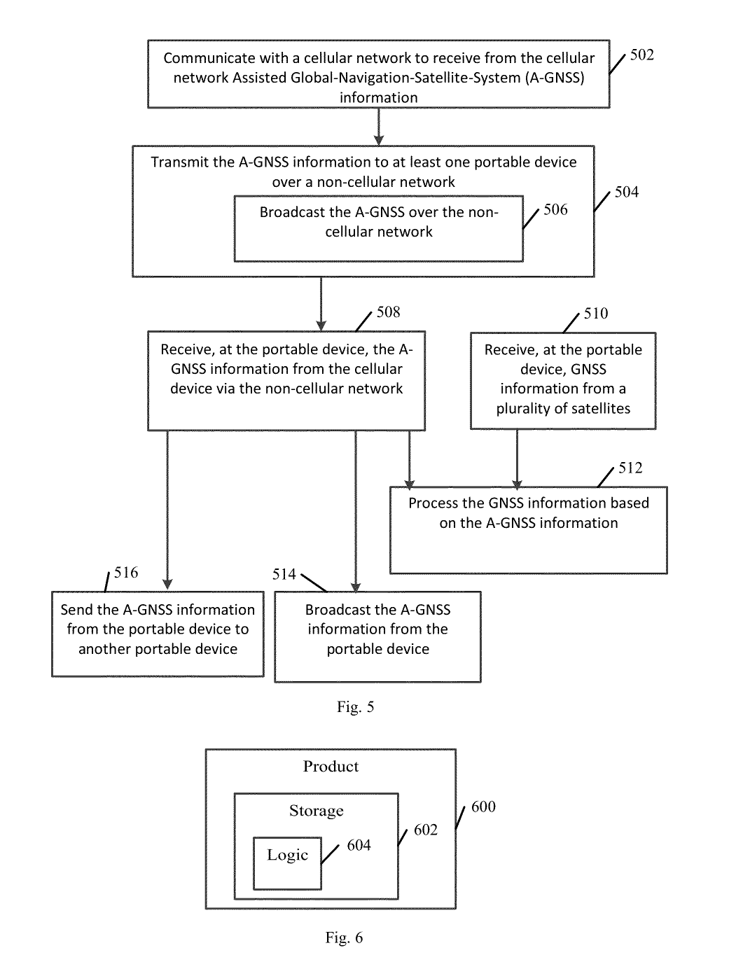

Reference is made to FIG. 5, which schematically illustrates a method of receiving A-GNSS information, in accordance with some demonstrative embodiments. For example, one or more of the operations of the method of FIG. 5 may be performed by a wireless communication system, e.g., system 100 (FIG. 1); a portable device, e.g., portable device 120 (FIG. 1); a cellular device, e.g., cellular device 140 (FIG. 1); a transceiver, e.g., transceivers 124, 144 and/or 156 (FIG. 1); a controller, e.g., controller 142 (FIG. 1); and/or a GNSS processor, e.g., GNSS processor 128 (FIG. 1).

As indicated at block 502, the method may include communicating with a cellular network to receive from the cellular network Assisted Global-Navigation-Satellite-System (A-GNSS) information. For example, cellular device 140 (FIG. 1) may communicate with server 155 (FIG. 1) to receive the A-GNSS information from cellular network 150 (FIG. 1), e.g., as described above.

As indicated at block 504, the method may include transmitting the A-GNSS information to at least one portable device over a non-cellular network. For example, cellular device 140 (FIG. 1) may transmit the A-GNSS information to portable device 120 via PAN 123 (FIG. 1), e.g., as described above.

As indicated at block 506, transmitting the A-GNSS information may include broadcasting the A-GNSS information over the non-cellular network. For example, cellular device 140 (FIG. 1) may broadcast the A-GNSS information over the non-cellular network, e.g., as described above.

As indicated at block 508, the method may include receiving, at the portable device, the A-GNSS information from the cellular device, via the non-cellular network. For example, portable device 120 (FIG. 1) may receive the A-GNSS information from cellular device 140 (FIG. 1), e.g., as described above.

As indicated at block 510, the method may include receiving, at the portable device, GNSS information from a plurality of satellites. For example, portable device 120 (FIG. 1) may receive GNSS information from satellites 130 (FIG. 1), e.g., as described above.

As indicated at block 512, the method may include processing, at the portable device, the GNSS information based on the A-GNSS information. For example, GNSS processor 128 (FIG. 1) may process the GNSS information based on the A-GNSS information, e.g., as described above.

As indicated at block 514, the method may include sending the A-GNSS information to another portable device over the non-cellular network. For example, portable device 120 (FIG. 1) may send the A-GNSS information to portable device 160 (FIG. 1), e.g., as described above.

As indicated at block 516, the method may include broadcasting the A-GNSS information from the portable via the non-cellular network. For example, portable device 120 (FIG. 1) may broadcast the A-GNSS information via the non-cellular network, e.g., as described above.

Reference is made to FIG. 6, which schematically illustrates a product of manufacture 600, in accordance with some demonstrative embodiments. Product 600 may include one or more tangible computer-readable non-transitory storage media 602 to store logic 604, which may be used, for example, to perform at least part of the functionality of portable device 120 (FIG. 1), transceiver 124 (FIG. 1), transceiver 144 (FIG. 1), transceiver 156 (FIG. 1), cellular device 140 (FIG. 1), controller 142 (FIG. 1), GNSS processor 128 (FIG. 1) and/or to perform one or more operations of the method of FIG. 5. The phrase “non-transitory machine-readable medium” is directed to include all computer-readable media, with the sole exception being a transitory propagating signal.

In some demonstrative embodiments, product 600 and/or media 602 may include one or more types of computer-readable storage media capable of storing data, including volatile memory, non-volatile memory, removable or non-removable memory, erasable or non-erasable memory, writeable or re-writeable memory, and the like. For example, media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 604 may include instructions, data, and/or code, which, when executed by at least one computer processor, may cause the computer to perform a method, process and/or operations as described herein. The computer may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes a portable device comprising a Global-Navigation-Satellite-System (GNSS) receiver to receive GNSS information from a plurality of satellites; a non-cellular transceiver to receive Assisted-GNSS (A-GNSS) information from a cellular device via a non-cellular network; and a processor to process the GNSS information based on the A-GNSS information.

Example 2 includes the subject matter of Example 1, and optionally, wherein the non-cellular transceiver is to send an assistance request to the cellular device, and to receive the A-GNSS in response to the assistance request.

Example 3 includes the subject matter of Example 1 or 2, and optionally, wherein the non-cellular transceiver is to receive the A-GNSS in a broadcast transmission from the cellular device.

Example 4 includes the subject matter of any one of Examples 1-3, and optionally, wherein the non-cellular transceiver is to receive from the cellular device a location request, wherein the processor is to estimate a location of the portable device based on the GNSS information and the A-GNSS information, and wherein the non-cellular transceiver is to send to the cellular device a position report based on the location of the portable device.

Example 5 includes the subject matter of Example 4, and optionally, wherein the non-cellular transceiver is to receive from the cellular device a location request notification, and to send to the cellular device a location request verification in response to the location request notification, and wherein the non-cellular transceiver is to receive the location request after sending the location request verification.

Example 6 includes the subject matter of Example 4 or 5, and optionally, wherein the location request comprises a Mobile Terminal Location Request (MTLR).

Example 7 includes the subject matter of any one of Examples 1-6, and optionally, wherein the non-cellular transceiver is to broadcast the A-GNSS information.

Example 8 includes the subject matter of any one of Examples 1-7, and optionally, wherein the non-cellular transceiver is to send the A-GNSS information to another portable device.

Example 9 includes the subject matter of any one of Examples 1-8, and optionally, wherein the processor is to process the A-GNSS information as part of at least one functionality selected from the group consisting of a mobile originate location request, a mobile terminated location request, an emergency position reporting, a Geo-reference (GEO) fencing, a GEO-logging, a Geo-caching, and a periodic reporting.

Example 10 includes the subject matter of any one of Examples 1-9, and optionally, wherein the non-cellular transceiver is to communicate with the cellular device via a personal area network (PAN).

Example 11 includes the subject matter of Example 10, and optionally, wherein the PAN comprises a wireless PAN.

Example 12 includes the subject matter of Example 11 wherein the wireless PAN comprises a Wireless-Fidelity (Wi-Fi) network, a Point-to-Point (P2P) network, or a Bluetooth (BT) network.

Example 13 includes the subject matter of Example 10, and optionally, wherein the PAN comprises a wired PAN.

Example 14 includes the subject matter of any one of Examples 1-13, and optionally, comprising a portable computer, a tablet computer, a laptop computer, an Ultrabook™ computer, a wearable device, or an Internet of Things (IoT) device.

Example 15 includes the subject matter of any one of Examples 1-14, and optionally, comprising a cellular-less device.

Example 16 includes a cellular device comprising a cellular transceiver to communicate with a cellular network, and to receive from the cellular network Assisted Global-Navigation-Satellite-System (A-GNSS) information; and a non-cellular transceiver to transmit the A-GNSS information to at least one portable device over a non-cellular network.

Example 17 includes the subject matter of Example 16, and optionally, wherein the non-cellular transceiver is to receive an assistance request from the portable device via the non-cellular network, and to transmit the A-GNSS in response to the assistance request.

Example 18 includes the subject matter of Example 16 or 17, and optionally, wherein the non-cellular transceiver is to broadcast the A-GNSS over the non-cellular network.

Example 19 includes the subject matter of Example 18, and optionally, wherein the non-cellular transceiver comprises a Frequency Modulation Radio (FMR) or a Digital Broadcast Radio (DBR) to broadcast the A-GNSS information.

Example 20 includes the subject matter of any one of Examples 16-19, and optionally, wherein the non-cellular transceiver is to transmit to the portable device a location request, and, in response to the location request, to receive from the portable device a position report including an estimated location of the portable device.

Example 21 includes the subject matter of Example 20, and optionally, wherein the non-cellular transceiver is to transmit to the portable device a location request notification, and to receive from the portable device a location request verification in response to the location request notification, and wherein the non-cellular transceiver is to transmit the location request after receipt of the location request verification.

Example 22 includes the subject matter of Example 20 or 21, and optionally, wherein the location request comprises a Mobile Terminal Location Request (MTLR).

Example 23 includes the subject matter of any one of Examples 16-22, and optionally, wherein the non-cellular transceiver is to communicate with the portable device via a personal area network (PAN).

Example 24 includes the subject matter of Example 23, and optionally, wherein the PAN comprises a wireless PAN.

Example 25 includes the subject matter of Example 24, and optionally, wherein the wireless PAN comprises a Wireless-Fidelity (Wi-Fi) network, a Point-to-Point (P2P) network, or a Bluetooth (BT) network.

Example 26 includes a method performed at a portable device, the method comprising receiving GNSS information from a plurality of satellites; receiving Assisted-GNSS (A-GNSS) information from a cellular device via a non-cellular network; and processing the GNSS information based on the A-GNSS information.

Example 27 includes the subject matter of Example 26, and optionally, comprising sending an assistance request to the cellular device, and receiving the A-GNSS in response to the assistance request.

Example 28 includes the subject matter of Example 26, and optionally, comprising receiving the A-GNSS in a broadcast transmission from the cellular device.

Example 29 includes the subject matter of any one of Examples 26-28, and optionally, comprising receiving from the cellular device a location request, estimating a location of the portable device based on the GNSS information and the A-GNSS information, and sending to the cellular device a position report based on the location of the portable device.

Example 30 includes the subject matter of Example 29, and optionally, comprising receiving from the cellular device a location request notification, sending to the cellular device a location request verification in response to the location request notification, and receiving the location request after sending the location request verification.

Example 31 includes the subject matter of Example 29 or 30, and optionally, wherein the location request comprises a Mobile Terminal Location Request (MTLR).

Example 32 includes the subject matter of any one of Examples 26-31, and optionally, comprising broadcasting the A-GNSS information.

Example 33 includes the subject matter of any one of Examples 26-32, and optionally, comprising sending the A-GNSS information to another portable device.

Example 34 includes the subject matter of any one of Examples 26-33, and optionally, comprising processing the A-GNSS information as part of at least one functionality selected from the group consisting of a mobile originate location request, a mobile terminated location request, an emergency position reporting, a Geo-reference (GEO) fencing, a GEO-logging, a Geo-caching, and a periodic reporting.

Example 35 includes the subject matter of any one of Examples 26-34, and optionally, comprising communicating with the cellular device via a personal area network (PAN).

Example 36 includes the subject matter of Example 35, and optionally, wherein the PAN comprises a wireless PAN.

Example 37 includes the subject matter of Example 36 wherein the wireless PAN comprises a Wireless-Fidelity (Wi-Fi) network, a Point-to-Point (P2P) network, or a Bluetooth (BT) network.

Example 38 includes the subject matter of Example 35, and optionally, wherein the PAN comprises a wired PAN.

Example 39 includes the subject matter of any one of Examples 26-38, and optionally, wherein the portable device comprises a portable computer, a tablet computer, a laptop computer, an Ultrabook™ computer, a wearable device, or an Internet of Things (IoT) device.

Example 40 includes the subject matter of any one of Examples 26-39, and optionally, wherein the portable device comprises a cellular-less device.

Example 41 includes a method performed at a cellular device, the method comprising communicating with a cellular network to receive from the cellular network Assisted Global-Navigation-Satellite-System (A-GNSS) information; and transmitting the A-GNSS information to at least one portable device over a non-cellular network.

Example 42 includes the subject matter of Example 41 comprising receiving an assistance request from the portable device via the non-cellular network, and transmitting the A-GNSS in response to the assistance request.

Example 43 includes the subject matter of Example 41, and optionally, comprising broadcasting the A-GNSS over the non-cellular network.

Example 44 includes the subject matter of any one of Examples 41-43, and optionally, comprising transmitting to the portable device a location request, and, in response to the location request, receiving from the portable device a position report including an estimated location of the portable device.

Example 45 includes the subject matter of Example 44, and optionally, comprising transmitting to the portable device a location request notification, receiving from the portable device a location request verification in response to the location request notification, and transmitting the location request after receipt of the location request verification.

Example 46 includes the subject matter of Example 44 or 45, and optionally, wherein the location request comprises a Mobile Terminal Location Request (MTLR).

Example 47 includes the subject matter of any one of Examples 41-46, and optionally, comprising communicating with the portable device via a personal area network (PAN).

Example 48 includes the subject matter of Example 47, and optionally, wherein the PAN comprises a wireless PAN.

Example 49 includes the subject matter of Example 48, and optionally, wherein the wireless PAN comprises a Wireless-Fidelity (Wi-Fi) network, a Point-to-Point (P2P) network, or a Bluetooth (BT) network.

Example 50 includes a product including one or more tangible computer-readable non-transitory storage media comprising computer-executable instructions operable to, when executed by at least one computer processor, enable the at least one computer processor to implement a method comprising receiving, at a portable device, GNSS information from a plurality of satellites; receiving, at the portable device, Assisted-GNSS (A-GNSS) information from a cellular device via a non-cellular network; and processing the GNSS information based on the A-GNSS information.

Example 51 includes the subject matter of Example 50, and optionally, wherein the method comprises sending an assistance request to the cellular device, and receiving the A-GNSS in response to the assistance request.

Example 52 includes the subject matter of Example 50, and optionally, wherein the method comprises receiving the A-GNSS in a broadcast transmission from the cellular device.

Example 53 includes the subject matter of any one of Examples 50-52, and optionally, wherein the method comprises receiving from the cellular device a location request, estimating a location of the portable device based on the GNSS information and the A-GNSS information, and sending to the cellular device a position report based on the location of the portable device.

Example 54 includes the subject matter of Example 53, and optionally, wherein the method comprises receiving from the cellular device a location request notification, sending to the cellular device a location request verification in response to the location request notification, and receiving the location request after sending the location request verification.

Example 55 includes the subject matter of Example 53 or 54, and optionally, wherein the location request comprises a Mobile Terminal Location Request (MTLR).

Example 56 includes the subject matter of any one of Examples 50-55, and optionally, wherein the method comprises broadcasting the A-GNSS information.

Example 57 includes the subject matter of any one of Examples 50-56, and optionally, wherein the method comprises sending the A-GNSS information to another portable device.

Example 58 includes the subject matter of any one of Examples 50-57, and optionally, wherein the method comprises processing the A-GNSS information as part of at least one functionality selected from the group consisting of a mobile originate location request, a mobile terminated location request, an emergency position reporting, a Geo-reference (GEO) fencing, a GEO-logging, a Geo-caching, and a periodic reporting.

Example 59 includes the subject matter of any one of Examples 50-58, and optionally, wherein the method comprises communicating with the cellular device via a personal area network (PAN).

Example 60 includes the subject matter of Example 59, and optionally, wherein the PAN comprises a wireless PAN.

Example 61 includes the subject matter of Example 60 wherein the wireless PAN comprises a Wireless-Fidelity (Wi-Fi) network, a Point-to-Point (P2P) network, or a Bluetooth (BT) network.

Example 62 includes the subject matter of Example 59, and optionally, wherein the PAN comprises a wired PAN.

Example 63 includes the subject matter of any one of Examples 50-62, and optionally, wherein the portable device comprises a portable computer, a tablet computer, a laptop computer, an Ultrabook™ computer, a wearable device, or an Internet of Things (IoT) device.

Example 64 includes the subject matter of any one of Examples 50-63, and optionally, wherein the portable device comprises a cellular-less device.

Example 65 includes a product including one or more tangible computer-readable non-transitory storage media comprising computer-executable instructions operable to, when executed by at least one computer processor, enable the at least one computer processor to implement a method comprising at a cellular device, communicating with a cellular network to receive from the cellular network Assisted Global-Navigation-Satellite-System (A-GNSS) information; and transmitting the A-GNSS information from the cellular device to at least one portable device over a non-cellular network.

Example 66 includes the subject matter of Example 65, and optionally, wherein the method comprises receiving an assistance request from the portable device via the non-cellular network, and transmitting the A-GNSS in response to the assistance request.

Example 67 includes the subject matter of Example 65, and optionally, wherein the method comprises broadcasting the A-GNSS over the non-cellular network.

Example 68 includes the subject matter of any one of Examples 65-67, and optionally, wherein the method comprises transmitting to the portable device a location request, and, in response to the location request, receiving from the portable device a position report including an estimated location of the portable device.

Example 69 includes the subject matter of Example 68, and optionally, wherein the method comprises transmitting to the portable device a location request notification, receiving from the portable device a location request verification in response to the location request notification, and transmitting the location request after receipt of the location request verification.

Example 70 includes the subject matter of Example 68 or 69, and optionally, wherein the location request comprises a Mobile Terminal Location Request (MTLR).

Example 71 includes the subject matter of any one of Examples 65-70, and optionally, wherein the method comprises communicating with the portable device via a personal area network (PAN).

Example 72 includes the subject matter of Example 71, and optionally, wherein the PAN comprises a wireless PAN.

Example 73 includes the subject matter of Example 72, and optionally, wherein the wireless PAN comprises a Wireless-Fidelity (Wi-Fi) network, a Point-to-Point (P2P) network, or a Bluetooth (BT) network.

Example 74 includes an apparatus comprising means for receiving, at a portable device, GNSS information from a plurality of satellites; means for receiving Assisted-GNSS (A-GNSS) information from a cellular device via a non-cellular network; and means for processing the GNSS information based on the A-GNSS information.

Example 75 includes the subject matter of Example 74, and optionally, comprising means for sending an assistance request to the cellular device, and receiving the A-GNSS in response to the assistance request.

Example 76 includes the subject matter of Example 74, and optionally, comprising means for receiving the A-GNSS in a broadcast transmission from the cellular device.

Example 77 includes the subject matter of any one of Examples 74-76, and optionally, comprising means for receiving from the cellular device a location request, estimating a location of the portable device based on the GNSS information and the A-GNSS information, and sending to the cellular device a position report based on the location of the portable device.

Example 78 includes the subject matter of Example 77, and optionally, comprising means for receiving from the cellular device a location request notification, sending to the cellular device a location request verification in response to the location request notification, and receiving the location request after sending the location request verification.

Example 79 includes the subject matter of Example 77 or 78, and optionally, wherein the location request comprises a Mobile Terminal Location Request (MTLR).

Example 80 includes the subject matter of any one of Examples 74-79, and optionally, comprising means for broadcasting the A-GNSS information.

Example 81 includes the subject matter of any one of Examples 74-80, and optionally, comprising means for sending the A-GNSS information to another portable device.

Example 82 includes the subject matter of any one of Examples 74-81, and optionally, comprising means for processing the A-GNSS information as part of at least one functionality selected from the group consisting of a mobile originate location request, a mobile terminated location request, an emergency position reporting, a Geo-reference (GEO) fencing, a GEO-logging, a Geo-caching, and a periodic reporting.

Example 83 includes the subject matter of any one of Examples 74-82, and optionally, comprising means for communicating with the cellular device via a personal area network (PAN).

Example 84 includes the subject matter of Example 83, and optionally, wherein the PAN comprises a wireless PAN.

Example 85 includes the subject matter of Example 84 wherein the wireless PAN comprises a Wireless-Fidelity (Wi-Fi) network, a Point-to-Point (P2P) network, or a Bluetooth (BT) network.

Example 86 includes the subject matter of Example 83, and optionally, wherein the PAN comprises a wired PAN.

Example 87 includes the subject matter of any one of Examples 74-86, and optionally, wherein the portable device comprises a portable computer, a tablet computer, a laptop computer, an Ultrabook™ computer, a wearable device, or an Internet of Things (IoT) device.

Example 88 includes the subject matter of any one of Examples 74-87, and optionally, wherein the portable device comprises a cellular-less device.

Example 89 includes an apparatus comprising means for communicating with a cellular network to receive from the cellular network Assisted Global-Navigation-Satellite-System (A-GNSS) information; and means for transmitting the A-GNSS information to at least one portable device over a non-cellular network.

Example 90 includes the subject matter of Example 89, and optionally, comprising means for receiving an assistance request from the portable device via the non-cellular network, and transmitting the A-GNSS in response to the assistance request.

Example 91 includes the subject matter of Example 89, and optionally, comprising means for broadcasting the A-GNSS over the non-cellular network.

Example 92 includes the subject matter of any one of Examples 89-91, and optionally, comprising means for transmitting to the portable device a location request, and, in response to the location request, receiving from the portable device a position report including an estimated location of the portable device.

Example 93 includes the subject matter of Example 92, and optionally, comprising means for transmitting to the portable device a location request notification, receiving from the portable device a location request verification in response to the location request notification, and transmitting the location request after receipt of the location request verification.

Example 94 includes the subject matter of Example 92 or 93, and optionally, wherein the location request comprises a Mobile Terminal Location Request (MTLR).

Example 95 includes the subject matter of any one of Examples 89-94, and optionally, comprising means for communicating with the portable device via a personal area network (PAN).

Example 96 includes the subject matter of Example 95, and optionally, wherein the PAN comprises a wireless PAN.

Example 97 includes the subject matter of Example 96, and optionally, wherein the wireless PAN comprises a Wireless-Fidelity (Wi-Fi) network, a Point-to-Point (P2P) network, or a Bluetooth (BT) network.

Example 98 includes a portable device comprising one or more antennas; a memory; a Global-Navigation-Satellite-System (GNSS) receiver to receive GNSS information from a plurality of satellites; a non-cellular transceiver to receive Assisted-GNSS (A-GNSS) information from a cellular device via a non-cellular network; and a processor to process the GNSS information based on the A-GNSS information.

Example 99 includes the subject matter of Example 98, and optionally, wherein the non-cellular transceiver is to send an assistance request to the cellular device, and to receive the A-GNSS in response to the assistance request.

Example 100 includes the subject matter of Example 98 or 99, and optionally, wherein the non-cellular transceiver is to receive the A-GNSS in a broadcast transmission from the cellular device.

Example 101 includes the subject matter of any one of Examples 98-100, and optionally, wherein the non-cellular transceiver is to receive from the cellular device a location request, wherein the processor is to estimate a location of the portable device based on the GNSS information and the A-GNSS information, and wherein the non-cellular transceiver is to send to the cellular device a position report based on the location of the portable device.

Example 102 includes the subject matter of Example 101, and optionally, wherein the non-cellular transceiver is to receive from the cellular device a location request notification, and to send to the cellular device a location request verification in response to the location request notification, and wherein the non-cellular transceiver is to receive the location request after sending the location request verification.

Example 103 includes the subject matter of Example 101 or 102, and optionally, wherein the location request comprises a Mobile Terminal Location Request (MTLR).

Example 104 includes the subject matter of any one of Examples 98-103, and optionally, wherein the non-cellular transceiver is to broadcast the A-GNSS information.

Example 105 includes the subject matter of any one of Examples 98-104, and optionally, wherein the non-cellular transceiver is to send the A-GNSS information to another portable device.

Example 106 includes the subject matter of any one of Examples 98-105, and optionally, wherein the processor is to process the A-GNSS information as part of at least one functionality selected from the group consisting of a mobile originate location request, a mobile terminated location request, an emergency position reporting, a Geo-reference (GEO) fencing, a GEO-logging, a Geo-caching, and a periodic reporting.

Example 107 includes the subject matter of any one of Examples 98-106, and optionally, wherein the non-cellular transceiver is to communicate with the cellular device via a personal area network (PAN).

Example 108 includes the subject matter of Example 107, and optionally, wherein the PAN comprises a wireless PAN.

Example 109 includes the subject matter of Example 108 wherein the wireless PAN comprises a Wireless-Fidelity (Wi-Fi) network, a Point-to-Point (P2P) network, or a Bluetooth (BT) network.

Example 110 includes the subject matter of Example 107, and optionally, wherein the PAN comprises a wired PAN.

Example 111 includes the subject matter of any one of Examples 98-110, and optionally, comprising a portable computer, a tablet computer, a laptop computer, an Ultrabook™ computer, a wearable device, or an Internet of Things (IoT) device.

Example 112 includes the subject matter of any one of Examples 98-111, and optionally, comprising a cellular-less device.

Example 113 includes a cellular device comprising one or more antennas; a memory; a cellular transceiver to communicate with a cellular network, and to receive from the cellular network Assisted Global-Navigation-Satellite-System (A-GNSS) information; and a non-cellular transceiver to transmit the A-GNSS information to at least one portable device over a non-cellular network.

Example 114 includes the subject matter of Example 113, and optionally, wherein the non-cellular transceiver is to receive an assistance request from the portable device via the non-cellular network, and to transmit the A-GNSS in response to the assistance request.

Example 115 includes the subject matter of Example 113 or 117, and optionally, wherein the non-cellular transceiver is to broadcast the A-GNSS over the non-cellular network.

Example 116 includes the subject matter of Example 115, and optionally, wherein the non-cellular transceiver comprises a Frequency Modulation Radio (FMR) or a Digital Broadcast Radio (DBR) to broadcast the A-GNSS information.

Example 117 includes the subject matter of any one of Examples 113-116, and optionally, wherein the non-cellular transceiver is to transmit to the portable device a location request, and, in response to the location request, to receive from the portable device a position report including an estimated location of the portable device.

Example 118 includes the subject matter of Example 117, and optionally, wherein the non-cellular transceiver is to transmit to the portable device a location request notification, and to receive from the portable device a location request verification in response to the location request notification, and wherein the non-cellular transceiver is to transmit the location request after receipt of the location request verification.

Example 119 includes the subject matter of Example 117 or 118, and optionally, wherein the location request comprises a Mobile Terminal Location Request (MTLR).

Example 120 includes the subject matter of any one of Examples 113-119, and optionally, wherein the non-cellular transceiver is to communicate with the portable device via a personal area network (PAN).

Example 121 includes the subject matter of Example 120, and optionally, wherein the PAN comprises a wireless PAN.

Example 122 includes the subject matter of Example 121, and optionally, wherein the wireless PAN comprises a Wireless-Fidelity (Wi-Fi) network, a Point-to-Point (P2P) network, or a Bluetooth (BT) network.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A portable device comprising:
a Global-Navigation-Satellite-System (GNSS) receiver to receive GNSS information from a plurality of satellites;
a non-cellular transceiver to receive Assisted-GNSS (A-GNSS) information from a cellular device via a non-cellular network; and
a processor to process said GNSS information based on said A-GNSS information.

2. The portable device of claim 1, wherein said non-cellular transceiver is to send an assistance request to said cellular device, and to receive said A-GNSS in response to said assistance request.

3. The portable device of claim 1, wherein said non-cellular transceiver is to receive said A-GNSS in a broadcast transmission from said cellular device.

4. The portable device of claim 1, wherein said non-cellular transceiver is to receive from said cellular device a location request, wherein said processor is to estimate a location of said portable device based on said GNSS information and said A-GNSS information, and wherein said non-cellular transceiver is to send to said cellular device a position report based on the location of said portable device.

5. The portable device of claim 4, wherein said non-cellular transceiver is to receive from said cellular device a location request notification, and to send to said cellular device a location request verification in response to said location request notification, and wherein said non-cellular transceiver is to receive said location request after sending said location request verification.

6. The portable device of claim 4, wherein said location request comprises a Mobile Terminal Location Request (MTLR).

7. The portable device of claim 1, wherein said non-cellular transceiver is to broadcast said A-GNSS information.

8. The portable device of claim 1, wherein said non-cellular transceiver is to send said A-GNSS information to another portable device.

9. The portable device of claim 1, wherein said processor is to process said A-GNSS information as part of at least one functionality selected from the group consisting of a mobile originate location request, a mobile terminated location request, an emergency position reporting, a Geo-reference (GEO) fencing, a GEO-logging, a Geo-caching, and a periodic reporting.

10. The portable device of claim 1, wherein said non-cellular transceiver is to communicate with said cellular device via a personal area network (PAN).

11. The portable device of claim 10, wherein said PAN comprises a wireless PAN.

12. The portable device of claim 1 comprising a portable computer, a tablet computer, a laptop computer, an Ultrabook™ computer, a wearable device, or an Internet of Things (IoT) device.

13. The portable device of claim 1 comprising:
one or more antennas; and
a memory.

14. A cellular device comprising:
a cellular transceiver to communicate with a cellular network, and to receive from said cellular network Assisted Global-Navigation-Satellite-System (A-GNSS) information; and
a non-cellular transceiver to transmit the A-GNSS information to at least one portable device over a non-cellular network.

15. The cellular device of claim 14, wherein said non-cellular transceiver is to receive an assistance request from said portable device via said non-cellular network, and to transmit said A-GNSS in response to said assistance request.

16. The cellular device of claim 14, wherein said non-cellular transceiver is to broadcast said A-GNSS over said non-cellular network.

17. The cellular device of claim 14, wherein said non-cellular transceiver is to transmit to said portable device a location request, and, in response to said location request, to receive from said portable device a position report including an estimated location of said portable device.

18. The cellular device of claim 17, wherein said non-cellular transceiver is to transmit to said portable device a location request notification, and to receive from said portable device a location request verification in response to said location request notification, and wherein said non-cellular transceiver is to transmit said location request after receipt of said location request verification.

19. The cellular device of claim 14 comprising:
one or more antennas; and
a memory.

20. A product including one or more tangible computer-readable non-transitory storage media comprising computer-executable instructions operable to, when executed by at least one computer processor, enable the at least one computer processor to implement a method comprising:
receiving, at a portable device, GNSS information from a plurality of satellites;
receiving, at said portable device, Assisted-GNSS (A-GNSS) information from a cellular device via a non-cellular network; and
processing said GNSS information based on said A-GNSS information.

21. The product of claim 20, wherein said method comprises receiving from said cellular device a location request, estimating a location of said portable device based on said GNSS information and said A-GNSS information, and sending to said cellular device a position report based on the location of said portable device.

22. The product of claim 21, wherein said method comprises receiving from said cellular device a location request notification, sending to said cellular device a location request verification in response to said location request notification, and receiving said location request after sending said location request verification.

23. A product including one or more tangible computer-readable non-transitory storage media comprising computer-executable instructions operable to, when executed by at least one computer processor, enable the at least one computer processor to implement a method comprising:
at a cellular device, communicating with a cellular network to receive from said cellular network Assisted Global-Navigation-Satellite-System (A-GNSS) information; and
transmitting the A-GNSS information from the cellular device to at least one portable device over a non-cellular network.

24. The product of claim 23, wherein said method comprises receiving an assistance request from said portable device via said non-cellular network, and transmitting said A-GNSS in response to said assistance request.

25. The product of claim 23, wherein said method comprises broadcasting said A-GNSS over said non-cellular network.
